(19) United States
(12) Patent Application Publication
(10) Pub. No.: US 2025/0373327 A1
(43) Pub. Date: Dec. 4, 2025

(54) 5G PLATFORM HAVING SATELLITE COVERAGE

(71) Applicants: THALES DIS FRANCE SAS, Meudon (FR); THALES, Meudon (FR)

(72) Inventors: Jean-Yves FINE, Marseille (FR); Mohamed EL JAAFARI, Auterive (FR); Dorin PANAITOPOL, La Garenne-Colombes (FR)

(73) Assignees: THALES DIS FRANCE SAS, Meudon (FR); THALES, Meudon (FR)

(21) Appl. No.: 18/864,077

(22) PCT Filed: May 11, 2023
(86) PCT No.: PCT/EP2023/062688

§ 371 Date: Nov. 8, 2024

(30) Foreign Application Priority Data
May 13, 2022 (EP) 22305714.2

(51) Int. Cl. H04B 7/185; H04W 60/04

(52) U.S. Cl. CPC H04B 7/1855; H04B 7/18589; H04W 60/04

(57) ABSTRACT

Provided is a coverage management network function integrated in a fifth-generation network core configured to operate in collaboration with a satellite system having dynamic coverage, the network core collaborating with an access network (RAN), said coverage management network function responding to the requirements defined for a service-based architecture for a network function, this coverage management network function being further configured to collect coverage information by the satellite system, to process this coverage information according to at least one geographical area defined by another network function of the core network, also satisfying the requirements defined for a service-based architecture, in order to generate access network availability information in real time and provide it to this other network function of the core network. Other embodiments are disclosed.

### TECHNICAL FIELD

The invention relates to the field of satellite telecommunications, with respect to integration of a satellite system with the 5th generation (5G) cellular network, as specified by the 3GPP standardization organization.

More specifically, the invention relates to a network function called coverage management, integrated in an active fifth-generation network core in collaboration with a satellite system.

The invention also relates to a network core comprising such a network function and a method implemented within a network function according to the invention.

### PRIOR ART

The 3GPP standardization organization produces standards defining the needs, architecture, and operation of the mobile communication system. The normative elements in relation to the satellite system, whether it is geostationary, low orbit or medium orbit, are in development.

In the context of the standardization of 5G networks, it is thus provided that a set of satellites, managed by a satellite control center, provide 5G mobile telephony coverage. This set of satellites, alone or in combination with a ground network, will thus constitute an access network to a network core administered by the mobile telephony operator. Such a network core implements the different functions inherent in this network: security, mobility management, billing, etc.

For different reasons, such as, for example, the progressive deployment of the constellation of satellites, by design the satellite systems do not allow total coverage of the globe or even of one area of the globe. Whether due to maintenance operations or to a partial failure of the satellite access system, it is thus possible that a given geographical area does not benefit from continuous satellite coverage. Such a discontinuity of coverage, recurrent or not, will have an impact on the 5G telecommunication system (5GS) as soon as the satellite systems are integrated therein.

There are currently Internet services for providing satellite coverage elements, for the example Iridium system: https://www.gsattrack.com/home/iridiumsatellites. However, this system is based on an Internet infrastructure with the advantages and disadvantages inherent in this infrastructure.

More precisely, in existing satcom satellite systems (therefore non-terrestrial telecommunications) there may be coverage holes. Such areas change continuously over minutes. These coverage fluctuations must be taken into account in the procedures required for operating the fifth-generation telecommunication network expecting to use satellite systems. This is particularly important, for example, for preserving the batteries of mobile terminals. Indeed, it is desirable for these terminals not to search for the satellite in an area that is not covered, and that they avoid carrying out registration/(de) registration operations and frequent location updates due to the intermittent nature of the coverage.

There are also coverage holes in ground networks, but the base stations do not have high mobility as in the satellite case. For ground networks coverage holes are fixed, in contrast to satellite networks where coverage holes are mobile and therefore more difficult to predict by a user apparatus.

For this reason, intelligent methods must be defined in the NetWork (NW) to be able to track the satellite dead areas/coverage holes and adapt mobility management procedures accordingly.

The provision of the satellite coverage elements is currently not defined by the 3GPP responsible for defining the 5G network. This causes 5G Network core functions, such as the AMF (Access and Mobility Management), responsible for managing Network Access and Terminal Mobility or the NEF (Network Exposure Function) giving information regarding the Network to third-party services, to have to interface with as many proprietary interfaces as the Iridium service, generating an additional cost of integration. In addition, a call to these elements each time it is needed may cause an overload of the network if a large number of user devices need information offered by these interfaces.

Today, there is a need for an effective and simple solution to deal with the dynamism of satellite coverage.

### SUMMARY OF THE INVENTION

The present invention aims to allow integrated tracking of satellite coverage in real time.

The present invention relates to a so-called coverage management network function integrated in a fifth-generation network core configured to operate in collaboration with a satellite system having dynamic coverage, the network core collaborating with an access network (RAN), said coverage management network function responding to the requirements defined for a service-based architecture for a network function, this coverage management network function being further configured to collect coverage information by the satellite system, to process this coverage information according to at least one geographical area defined by another network function of the core network, also satisfying the requirements defined for a service-based architecture, in order to generate access network availability information in real time and provide it to this other network function of the core network.

The invention therefore proposes the characterization of the coverage of an area by the satellite system and the supply thereof to the elements of the 5G network core. The invention thus proposes a network function (NF) in the meaning of the standard, this network function being dedicated to the collection and provision of coverage information to the entities that need it in order to adapt the other network functions accordingly. The invention defines a new core Network Function (NF) in the service-based architecture (SBA). The invention operates as a centralized platform for providing satellite coverage information integrated into the 5G network.

It is remarkable that the service-based architecture, not at all mentioned above in the context of the invention, is particularly well suited to the need for periodic requests for satellite coverage as well as to providing notifications when the coverage changes. No known solution for determining satellite coverage also allows providing notifications sent automatically to the network functions. The benefit and originality of the invention are well understood here.

Moreover, the fact of creating an architecture, in a unique, centralized, and shared manner for all network functions, allows all these functions to share the same information. This is particularly useful for the implementation of common algorithms if applicable. This will in particular be the case for managing the mobility of terminals and optimizing the battery lifetime of terminals. All the network functions share the same unique, homogeneous and pooled information. Such advantages are unknown in prior art solutions.

It thus proposes the integration of the characterization service in the architecture of the core network, according to the modalities defined by the 3GPP, according to the “Service-Based Architecture” (SBA) concept.

With respect to a service accessible on the Internet, a NF network function integrated with the SBA in particular has the following advantages inherent in the SBA architecture:
Normalization of the interfaces and methods for accessing the information enabling the centralization and distribution to the other network functions (NF) of the same information, here in particular mappings, events etc.
Pooling the collection of information on the satellite coverage,
Security,
Integration with the virtualization and slicing policy of the operator's NFs,
Life cycle management functions common to other NFs. It is remarkable that the invention proposes these advantages for a satellite coverage management service. Indeed, these advantages are not especially the first things sought after when a person skilled in the art examines the problem of dynamic satellite coverage.

The invention can thus be deployed on all fifth-generation networks, thus implementing a service-based architecture having possible satellite network access and which would wish to integrate the satellite coverage forecasts.

According to an advantageous feature, the processing of the information comprises an extrapolation of the satellite coverage according to the collected satellite coverage information, the availability information being a function of this extrapolation.

By using an extrapolation of the collected information, the network function can generate future coverage information in real time and provide it over a variable time period following the provision of the coverage information. This allows the entity that needs to know the status of the coverage to manage its connections as a function of time and coverage forecasts made accessible by the provision of information according to the invention.

Advantageously, the coverage information includes satellite operation and maintenance information, ephemerides of the satellites, beam direction information, etc.

This coverage information allows the network function to know the current status of the coverage and to generate the network availability information based on a faithful reflection of the reality of the operation and of the movement of the satellites.

According to an advantageous embodiment, the network function is further configured to collect, additionally, ground coverage information, the processing of the coverage information integrating this ground coverage information so as to generate availability information of the access network in real time and provide it, taking into account the satellite coverage and the ground coverage.

Adding information about the access network available on the ground makes it possible to inform the network functions that require the network function according to the invention about the possibility of switching over to the ground network if necessary during a period in which the satellite coverage does not offer the possibility of access to the network.

According to a first operating mode, the network function is further configured for:
receiving an availability request from another network function according to the service-based architecture, this availability request including a geographical area,
generating in real time and providing, in response to the availability request, availability information comprising a coverage status at the time of receipt of the request.

This operating mode corresponds to the first request/response operating mode as defined in the service-based architecture defined in the standardized documents. It allows any network function to periodically request, if necessary, the network function of the invention. It is noted here that the call to the entity that manages the coverage, here, then, the coverage management network function, is particularly simple and easy in terms of implementation and integration in the network cores as defined in the standards. This is not the case in the prior art solutions.

Advantageously, the availability information further comprises timing elements of coverage and absence of coverage over the geographical area.

This feature ensures that the network function will have sufficient elements, for example, for appropriately modifying an operation of a user apparatus in a future period following reception of the response to its request.

According to an advantageous feature, the availability request further comprises an indication of total or partial coverage, the availability information then further comprising total or partial coverage information.

Such an indication makes it possible to meet the real need for the network function by taking into account the need for total or partial coverage over the geographical area concerned.

According to another mode of operation, the network function is configured to receive a registration request from another network function according to the service-based architecture, to be registered with a service for sending availability notification, these registration requests including a geographical area,
during a change in the status of coverage over the geographical area of the registration, generating in real time and providing a notification to the network functions registered on the service, this notification comprising availability information including timing elements of coverage and absence of coverage over the geographical area.

This mode of operation corresponds to the registration/notification mode as defined in the service-based architecture of the standards. It allows any network function to register in order to be kept up to date on the evolution of the coverage over a given geographical area. It is noted here that this registration system allowing the shared sending of notification giving the network availability information is not currently in the objectives targeted by the integration of a satellite system in a fifth-generation network. The invention makes it possible to perform this automatic sending in a simple and easy way in terms of implementation and integration in the network cores as defined in standards. No solution of the known prior art provides this service.

Here also, advantageously, the availability information includes timing elements of coverage and absence of coverage over the geographical area.

Also, advantageously, the registration request further comprising an indication of total or partial coverage, the availability information then further comprises total or partial coverage information.

The invention also relates to a fifth-generation network core configured to operate in collaboration with a satellite system having dynamic coverage, the network core collaborating with an access network (RAN), said network core comprising a coverage management network function according to the invention, thus responding to the requirements defined for a service-based architecture for a network function, this coverage management network function thus being configured to collect coverage information by the satellite system and to process this coverage information according to at least one geographical area defined by another network function of the network core, also satisfying the requirements defined for a service-based architecture, to generate availability information of the access network in real time and provide it to this other network function of the network core.

The present invention therefore proposes to develop the architecture of the network cores in order to take into account the specific features of the satellite system.

Finally, the invention relates to a method for managing coverage implemented within a coverage management network function of the invention, this network function being integrated into a fifth-generation network core configured to operate in collaboration with a satellite system having dynamic coverage, the network core collaborating with an access network (RAN), said coverage management network function meeting the requirements defined for a service-based architecture for a network function,

the method comprising the steps of, for the coverage management network function:
collecting coverage information by the satellite system,
processing this coverage information based on at least one geographical area defined by another network function of the core network also satisfying the requirements defined for a service-based architecture,
generating access network availability information in real time and providing it to this other network function of the core network.

This coverage management method implemented in a network function makes it possible to carry out the collection, processing of information, generation and the provision of availability information for the access network. It may also advantageously have all the features as described above for a network function.

In general, it is noted here that the various features and embodiments/operation can be implemented alone or in combination or juxtaposition with one or the other of the features and embodiments as claimed. One embodiment can therefore be implemented concomitantly with another. This makes it possible in particular to deal with different situations depending on the context or need encountered. In particular, it is clear that the two embodiments on request or on registration on a notification service can be implemented together within the same network function.

It is also noted here that the claims were centered on a network function having specific features and behaviors. It goes without saying that any claim of another category, for example aiming at a core network comprising such a network function with these same features and behaviors, is to be considered as described in the present application and can be subsequently claimed as such.

The same applies to the method according to the invention which may also have all the features and behaviors/configurations as claimed for the network function and these characteristics and behaviors/configurations may later be claimed as such. In particular, the features relating to the timing elements of coverage and absence of coverage and to the total or partial coverage mode indication also relate to the method according to the invention and can be features claimed later.

For the performance of the preceding objectives and related objectives, several embodiments comprise the features described below in a complete and detailed manner.

### BRIEF DESCRIPTION OF THE FIGURES

The following description and the accompanying drawings illustrate in detail some illustrative aspects and represent only a few of the various ways in which the principles of the invention can be employed. Other advantages and features will become apparent from the following detailed description, when considered in conjunction with the drawings, and the disclosed embodiments are intended to include all these aspects and equivalents thereof.

FIG. 1 schematically shows the integration of the network function defined according to the invention within a 5G network core;

FIG. 2 schematically shows the definition of areas useful for the implementation of the invention;

FIG. 3 schematically shows a request/response mechanism according to the 3GPP standard defining the SBA architecture; and

FIG. 4 schematically shows a mechanism for subscribing to an event according to the 3GPP standard defining the SBA architecture.

### DETAILED DESCRIPTION OF THE FIGURES AND EMBODIMENTS

For a more complete understanding of the invention, it will now be described in detail with reference to the appended Figures. The detailed description will illustrate and describe what is considered as a preferred embodiment of the invention. It is of course understood that various modifications and changes of form or detail could easily be made without departing from the scope of the invention. It is therefore provided that the invention is not limited to the exact form and details shown and described herein, nor to any less than the assembly of the invention disclosed herein and claimed below. The same elements have been designated by the same references in the various drawings. For reasons of clarity, only the elements and the steps which are useful to the understanding of the present invention have been shown in the drawings and will be described.

The architecture of the core network, as defined by the 3GPP under the name of “service-based architecture/SBA” consists of a set of functions producing interfaces enabling the interoperation and the progress of the procedures necessary for the operation of the network. It is specified by the attached set of standards TS 29.500, TS 23.501, TS 23.502. In the table below, a list of such network functions defined in the architecture specification TS 23.501 is shown.

A particular function is the “NRF” (Network Repository Function), the role of which is to maintain a catalog of services offered by all of the other network functions and accessible by all of the other network functions. The network function according to the invention is thus listed within the NRF network directory function with the other network functions capable of calling itself.

| | |
|---|---|
| UDSF | Unstructured Data Storage Function |
| UDM | Unified Data Management |
| UDR | Unified Data Repository |
| NEF | Network Exposure Function |
| NSSF | Network Slice Selection Function |
| AUSF | Authentication Server Function |
| SMSF | SMS Function |
| EIR | 5G Equipment Identity Register |
| LMF | Location Management Function |
| AMF | Access and Mobility Management Function |
| SMF | Session Management Function |
| PCF | Policy Control Function |
| UPF | User Plane Function |
| N31WF | Non-3GPP Interworking Function |
| SEPP | Security Edge Protection Proxy |

The use of these functions is carried out using the procedures as described in the TS standards cited above.

In this context, the invention can be designated by the acronym CMNF, for “Coverage Management Network Function”, or “Coverage Management & Monitoring Network Function”. This is a new function to add to the 5G network core architecture, defined by the “§ 5.2 Architecture Reference Model” of the technical specification TS 23.501.

Like the other NFs, the CMNF network function therefore records its services from the “Network Repository Function” (NRF) so that all the other functions of the core network, e.g., AMF, SMF, PCF, NEF or others, can use it.

This new function performs specific actions and can be used to produce specific data as described below.

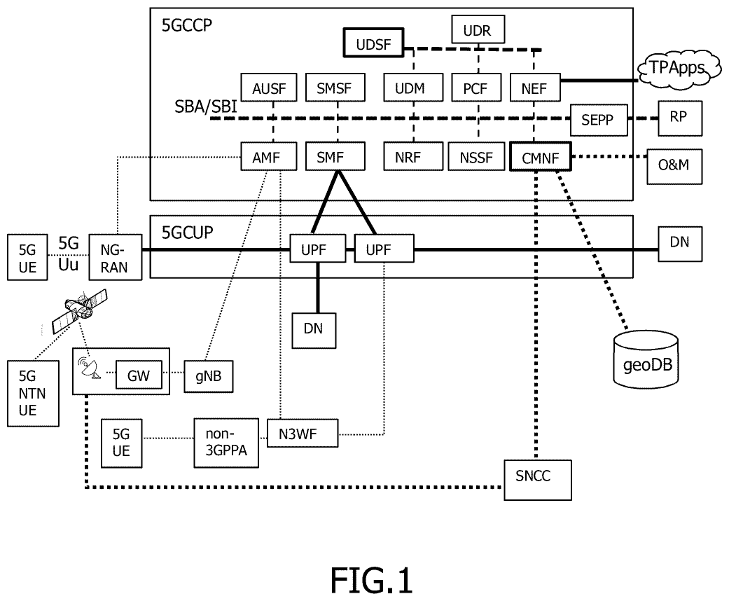

FIG. 1 schematically shows the integration of a network function according to the CMNF invention within a core network such as exists according to the 3GPP standard for fifth-generation telecommunications.

As shown in this Figure, a network core consists of a control plan 5GCCP where all of the network functions and a user plan 5GCUP are grouped together according to the architectural slice defined in the 3GPP standards. A 5G UE mobile terminal will be able to connect via the 5G access network, called NG-RAN, and therefore have access to all gNB base stations according to the terminology.

If the terminal, denoted 5G NTN UE in FIG. 1, supports satellite access, for the latter to be effective, it will be necessary for at least one base station gNB to be connected to a gateway GW that will enable communication with the terminal 5G UE via the satellite.

This gNB/GW assembly is in relation to a control center of the Satellite Network Control Center (SNCC) satellite system. For the needs of the invention, this CNCC control center is itself in relation to the CMNF coverage management network function to provide the path elements of the satellites. The CMNF network function is also in relation to an operating and maintenance system O&M of the 5G network, which makes it possible to know the operating status of the elements specific to it and the network planning elements, for example “tracking areas” in the sense of the standard. The CMNF network function can also be in relation to a geographic database geoDB to access ground description elements. This is useful in order to better characterize, if necessary, the geographical area on which the requests or the records of the other network functions bear.

The two main features of the invention are therefore the generation in real time of the footprint of the satellites on the ground and the integration of the information collection and provision function in the SBA architecture. These two characteristics are carried out by the CMNF network function of the invention so as to allow integration into the virtualization strategy of the 5G network core.

Thus, for the real-time generation of the footprint of the satellites on the ground, the CMNF network function of the invention collects the positioning elements of the satellites and of coverage of these satellites, updated as needed.

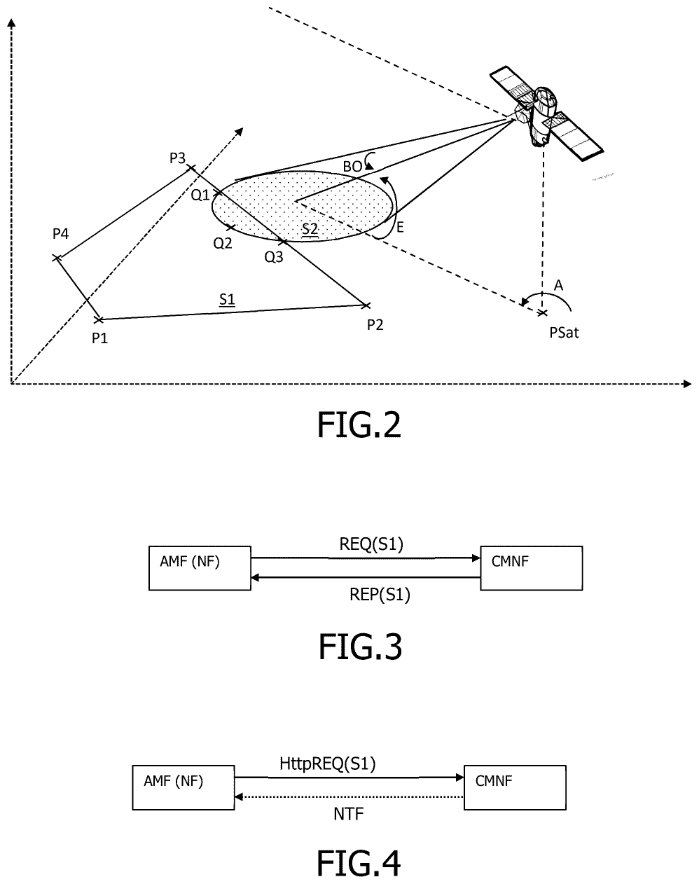

FIG. 2 shows, inter alia, a footprint S2 of a satellite on the ground. According to an advantageous embodiment, this footprint S2 is calculated with the coordinates defining the position of the satellite, the angles, that is, elevation E, azimuth A, defining the orientation of the beam BO and the opening angle of the beam.

The CMNF network function collects elements provided by the SNCC control center of the satellite system, whether ephemerides describing the paths of the various satellites, parameters for identifying the beams, generally an identifier of the radio cell and a beam index, parameters for characterizing the beams, in particular size and orientation.

The CMNF network function of the invention also collects elements provided by an operations and maintenance center of the 5G system, or a mapping of the tracking areas, an operating status of the beams, in particular if the beam is functional or not.

Advantageously, the SNCC control center also receives operations and maintenance information from an entity of the 5G network, which proceeds with the operations and maintenance of the satellite system.

Then, on the ground geographical database geoDB, the CMNF network function calculates, as a function of time, the status of exposure of a given area, as well as the next period of coverage and of non-coverage.

Integration into the SBA architecture requires any network function to provide a programmatic interface, that is, an API, accessible for all clients, that are the other network functions NFs, making service requests and/or subscribing to the service to receive notifications, as described in § 7.1 Network Function Service Framework of 3GPP standard TS 23.501. Thus, the network function according to the invention respects the SBA architecture and therefore operates in a request/response mechanism or in subscription/notification mode.

These two operating modes are illustrated in FIGS. 3 and 4 respectively.

In FIG. 3, an AMF (Access Mobility Function) or another network function NF needs to know the satellite coverage for a given service for a given user apparatus whose location is known at least approximately by the AMF Function. According to the invention, it simply makes a request REQ(S1) specifying a geographical area S1 where the user device is located to the CMNF function of the invention while complying with the requirements defined in the standard TS29.500, and it receives in response the coverage REP(S1) status on the area S1, the area where a user apparatus needing to know the satellite coverage is generally positioned.

As shown in FIG. 2, the request made by any network element will thus more precisely contain at least the coordinates of several points P1, P2, P3, P4 defining a geographical area S1 for which the status of the coverage needs to be known and, advantageously, a mode defining whether or not the partial coverage must be considered. The partial coverage mode will make it possible to account for the fact that the satellite beam will cover only a portion of the area. The knowledge of this portion may be correlated with other information, such as a more precise location of a terminal for which the coverage management network function has been requested, in order to know whether the terminal can receive the satellite signal during the next overflight of the area or not. If only the total coverage in a corresponding full coverage mode is required on the queried area, only total coverage of the area will be reported by the CMNF network function.

In a case where more than two points are provided, the request will therefore relate to a surface area S1 defined in FIG. 2 by four points P1, P2, P3 and P4. It is noted here that it is also conceivable that the definition of the contours is known by configuring the CMNF network function. In the latter case, only a contour identifier X can be asked for in the request, e.g., tracking area X.

The CMNF network function will, from the reupdated footprints of the satellites on the ground S2, calculate and return in the response the status of coverage at the time of receipt of the request: covered, not covered, partially covered. Advantageously more precise information is also provided such as start and end timing elements where S1 will be covered by S2(x) at 0%, thus defining a “coverage hole”, regardless of the beam(x) and start and end timing elements where S1 will be covered by S2(x) to CovPercentageMax (>0%-“partial or total illumination”), regardless of the beam(x).

CovPercentageMax is the maximum percentage of the surface S1 covered by S2(x) when the beam (x) passes through the area. If CovPercentageMax<100, and the “partial coverage” mode is requested, then the response advantageously contains a parameter CovPerPercentage, of the coordinates on the terrestrial surface of the satellite (PSat) at the time of the maximum coverage, of the coordinates of at least 3 points Q1, Q2, Q3 such as located on the border of the beam inside the surface area S1, if applicable, of the start and end timing elements where S1 will be covered at 100%. Advantageously, the response also contains information elements enabling the unique identification of the beam in the system, or the type of satellite, that is, LEO, MEO, GEO, other, and an identifier of the radio cell and a beam index.

Thus, in summary, in a request/response mode, an element of the network, for example the AMF, will request coverage information by identifying an area. The CMNF network function of the invention will provide in response several of these elements: a current coverage status (covered, not covered, partially covered), the type of cover: LEO, GEO, MEO or the like, start and end timing elements of the next interval (or future intervals), duration(s) or period(s), start and end timing elements of the next coverage hole(s), an identifier of the next beam (cell, satellite identity) and that of the current beam if there is coverage.

According to the principles of SBA architecture, the CMNF network function will have to provide an interface under the name “Ncmnf_communication”. This is defined in the standard documents.

In FIG. 4, the AMF function, or another network function NF, performs a registration request HttpREQ(S1) from the CMNF function of the invention by signaling an area S1 to receive notifications relating to the satellite coverage for the geographical frame S1 defined in the registration.

For this registration, in an implementation example, the AMF function sends the following URI request to the CMNF function; {apiRoot}/{apiName}/{apiVersion}/{apiSpecificResourceUriPart} http://10.0.0.1/Ncmnf_EventExpose/v1/apiSpecificResourceUriPart

In this request, an element of the network wishing to subscribe to monitoring the coverage of an area provides at least coordinates of several points, or a preconfigured outline identifier, and advantageously a mode defining whether or not the partial coverage needs to be considered.

The CMNF network function will periodically repeat in the background the same calculations as those described above. It will trigger a NTF notification when the following events occur:
Area under coverage. In this case, if the partial coverage mode is requested, it will advantageously contain values defined above: CovPercentageMax, coordinates at the terrestrial surface of the satellite (PSat), set of points {Qi} as defined previously.
Area out of coverage (0%),

To this NTF notification information elements will advantageously be associated as defined previously, allowing the unique identification of the beam in the system.

Thus, in summary, in a subscription/notification mode, a network function, for example the AMF, subscribes to monitoring the coverage of an area. The CMNF network function then triggers a notification, during the next occurrence of the event concerned, in particular, area under coverage, outside coverage area.

Here too, according to the principles of SBA architecture, the CMNF network function for the service above must provide an interface under the name Ncmnf_EventExposure.

Moreover, the storage of the generated information may be done by using a network function for storing the unstructured data UDSF (“Unstructured Data Storage Function”).

In summary, the invention thus proposes the integration of the provision of satellite coverage elements in the SBA architecture of the 3GPP standard to benefit from the advantages inherent in the SBA architecture, allowing the centralization and pooling of the coverage data, thus avoiding the use of proprietary dynamic databases.

The invention makes it possible to extrapolate coverage features for a future time upon request from a client subscriber to its services. For example, it will be very useful to an airplane served by the 5G satellite network to predict in advance non-coverage areas and the time and duration during which those areas will be overflown.

In the detailed description above, reference is made to the appended drawings which show specific embodiments in which the invention can be implemented. These embodiments are described in a sufficiently detailed manner to allow a person skilled in the art to implement the invention. The detailed description above should therefore not be taken in a limiting sense, and the scope of the present invention is defined only by the appended claims, interpreted appropriately.

What is claimed, is:

1. A network function referred to as coverage management integrated in a fifth-generation network core configured to operate in collaboration with a satellite system having dynamic coverage, the network core collaborating with an access network (RAN), said coverage management network function responding to the requirements defined for a service-based architecture for a network function, this coverage management network function further being configured to collect coverage information by the satellite system, to process this coverage information according to at least one geographical area defined by another network function of the core network, also satisfying the requirements defined for a service-based architecture, in order to generate access network availability information in real time and provide it to this other network function of the core network.

2. The coverage management network function according to claim 1, wherein the processing of the information comprises an extrapolation of the satellite coverage according to the collected satellite coverage information, the availability information being a function of this extrapolation.

3. The coverage management network function according to claim 1, wherein the coverage information includes satellite operation and maintenance information, ephemerides of the satellites, beams orientation information.

4. The coverage management network function according to claim 1, further configured to additionally collect ground coverage information, the processing of the coverage information integrating this ground coverage information so as to generate availability information of the access network in real time and provide it, taking into account the satellite coverage and the ground coverage.

5. The coverage management network function according to claim 1, further configured for:
receiving an availability request from another network function according to the service-based architecture, this availability request including a geographical area,
generating in real time and providing, in response to the availability request, availability information comprising a coverage status at the time of receipt of the request.

6. The coverage management network function according to claim 5, wherein the availability information further comprises timing elements of coverage and absence of coverage over the geographical area.

7. The coverage management network function according to claim 5, wherein, the availability request further comprising an indication of total or partial coverage, the availability information then further comprises total or partial coverage information.

8. The coverage management network function according to claim 5, further configured for:
receiving a registration request from another network function according to the service-based architecture, to be registered with a service for sending availability notification, these registration requests including a geographical area,
during a change in the status of coverage over the geographical area of the registration, generating in real time and providing a notification to the network functions registered on the service, this notification comprising availability information including timing elements of coverage and absence of coverage over the geographical area.

9. The coverage management network function according to claim 9, wherein the availability information includes timing elements of coverage and absence of coverage over the geographical area.

10. The coverage management network function according to claim 8, wherein, the registration request further comprising an indication of total or partial coverage, the availability information then further comprises total or partial coverage information.

11. A fifth-generation network core configured to operate in collaboration with a satellite system having dynamic coverage, the network core collaborating with an access network (RAN), said network core comprising a coverage management network function according to one of the preceding claims, thus responding to the requirements defined for a service-based architecture for a network function, this coverage management network function thus being configured to collect coverage information by the satellite system, in order to process this coverage information according to at least one geographical area defined by another network function of the core network, also satisfying the requirements defined for a service-based architecture, in order to generate access network availability information in real time and provide it to this other network function of the core network.

12. A method for coverage management implemented within a coverage management network function according to one of claims 1 to 10, this network function being integrated into a fifth-generation network core configured to operate in collaboration with a satellite system having dynamic coverage, the network core collaborating with an access network (RAN), said coverage management network function responding to the requirements defined for a service-based architecture for a network function,
the method comprising the steps of, for the coverage management network function:
collecting coverage information by the satellite system;
processing this coverage information based on at least one geographical area defined by another network function of the core network also satisfying the requirements defined for a service-based architecture; and
generating access network availability information in real time and providing it to this other network function of the core network.

13. The method according to claim 12, wherein the step of processing the information comprises an extrapolation of the satellite coverage according to the collected satellite coverage information, the availability information being a function of this extrapolation.

14. The method according to claim 12, wherein the collecting step comprises collecting, additionally, ground coverage information, the step of processing the coverage information integrates this ground coverage information and the step of generating and providing availability information of the access network taking into account the satellite coverage and the ground coverage.

15. The method according to claim 12, the method comprising a preliminary step of receiving an availability request from another network function according to the service-based architecture, this availability request including a geographical area, the availability information thus being generated and provided in response to the availability request and comprising a coverage status at the time of receipt of the request.

16. The method according to claim 12, the method comprising a preliminary step of receiving a registration request from another network function according to the service-based architecture, in order to be registered with a service for sending availability notification, these registration requests including a geographical area, and, during a change in the status of the coverage over the geographical area of the registration, a step of sending a notification to the network functions registered on the service, this notification carrying out the provision of the availability information generated in real time.
